(19) United States
(12) Patent Application Publication
(10) Pub. No.: US 2009/0217783 A1
(43) Pub. Date: Sep. 3, 2009

(54) PEDAL WITH PANTOGRAPH DEVICE

(76) Inventor: Michel Garnier, Windhof (LU)

Correspondence Address: YOUNG & THOMPSON, 209 Madison Street, Suite 500, ALEXANDRIA, VA, 22314, US

(21) Appl. No.: 12/302,079

(22) PCT Filed: May 21, 2007
(86) PCT No.: PCT/FR07/00850

§ 371 Date: Mar. 23, 2009

(30) Foreign Application Priority Data
May 24, 2006 (FR) 0604723

(51) Int. Cl. B62M 3/08; B62M 3/02

(52) U.S. Cl. 74/594.6; 74/594.7

(57) ABSTRACT

A bicycle pedal (1) mounted at the end (3) of a pedal assembly crank arm (5), includes a main body (7) whereon a cyclist's foot is supported while cycling, the pedal (1) being assembled, along a link axis X₁, to the crank arm (5). The pedal (1) includes an intermediate pantograph device (11) for assembling the body (7) to the crank arm (5) producing both a variable offset of the foot purchase on the body (7) relative to the link axis X₁ to increase the cycling torque, and to direct the body (7) in a plane defined during the rotation of the crank arm over one pedalling cycle. Bicycles equipped with this type of pedal (1) are also disclosed.

The invention relates to a cycle pedal and to cycles equipped with such pedals. It will find its application in particular with cycle manufacturers and distributors, both in the field of sporting competition cycles and in that of city cycles.

Conventional pedals are fixed directly to the end of the cranks of a cycle crankset, generally by means of a spindle mounted with a pivot connection. The cyclist exerts a force with the sole of the foot on the body of the pedals which is transmitted to the cranks, thus producing a torque on the crankset, hence the rotation of the crankset chainrings which transmit the movement to the rear wheel.

Improved pedals are known, such as those described in the patent application in France published under number FR 2 880 863, or else in the patent application in France published under number FR 2 623 769. These pedals make it possible to create a shift of the point of pressing of the foot on the pedal with respect to the fixing axis of the crank and therefore to increase the lever arm during pedalling; the cyclist thus provides a smaller force for a delivered power equivalent to that obtained with a conventional pedal, which allows him to save energy.

The pedals consist of a body allowing either direct pressing of the shoe of the cyclist, in particular for city cycles, or fixing of the shoe by latching it on clamping means implemented on said body, in particular on sporting competition cycles. The pedals have the major drawback of not keeping a well-defined orientation when the foot of the user is no longer in contact with the body of the pedal. This is because the body of the pedal is articulated according to an axis of pivot corresponding either to the connecting axis of the crank, or to an offset axis via an intermediate assembly component of the cam type. In both these cases, the pedal tends to change orientation when the shoe relaxes its pressure or becomes detached from the pedal body, this change in orientation being due to the balancing deficiency of the pedal and to the fact that the pedal is articulated according to a single axis. The cyclist may then experience difficulties in repositioning his feet quickly on the pedals when he restarts.

Extendable cranks are also known, such as those described in the international patent application published under number WO 01/30642, or in the patent application in Germany published under number DE 117 906, or else in the patent application in France published under number FR 891 873. These cranks, which are disposed between the spindle of the crankset and that of the pedal, comprise a pantograph and/or cam device making it possible to vary their length. Moreover, these cranks are such that their length is maximum during the driving downward phase of the pedal and minimum during the upward phase of the pedal. The shift of the point of pressing of the foot with respect to the axis of the crankset, thus obtained, makes it possible to vary the lever arm and generate in particular a maximum driving power with a minimum force of the cyclist. However, the cranks described do not propose any means guaranteeing an orientation of the pedals allowing quick repositioning of the feet on said pedals.

The main aim of the present invention is to design a pedal whereof the mechanism makes it possible to increase the lever arm during pedalling by creating a shift of the point of pressing of the foot on the pedal with respect to the fixing axis of the crank. Another objective of the present invention is to implement means making it possible to impose and keep an orientation of the body of the pedal in a defined plane when the crank is situated in a first angular arc, this plane being for example substantially horizontal, and then allow said pedal body a certain freedom when the crank is situated in a second angular arc, complementary to the first angular arc, in order to allow the cyclist to orient the pedal body to his liking. Thus, the pedal that is the object of the invention has the advantage of facilitating the positioning of the foot on said body, such as for example on city cycles where the cyclist has to stop and put his feet down on the ground often on account of the traffic. Similarly, it makes it possible to increase the speed of engagement of the shoe on the clamping means provided on the pedal body equipping more particularly competition cycles.

Another aim of the present invention is to design a pedal whereof the mounting on the crank can be modified very easily in order to adapt the cycle to the morphology of the cyclist and thus optimise pedalling. For this, the pedal according to the invention has the advantage of allowing a modification of the mechanism for mounting said pedal on the crank, said modification having the aim of refining the path of the point of pressing of the foot during a rotation cycle of the crank, in order to provide pedalling conditions adapted and refined precisely to each user. To that end, the invention proposes a cycle pedal mounted at the end of a crankset crank, comprising a main body on which a cyclist foot presses during pedalling, said pedal being assembled, according to a connecting axis X₁, with the crankset crank. The pedal is remarkable in that it comprises an intermediate pantograph device making it possible to assemble the body of the pedal with the crank while at the same time creating a variable shift of the point of pressing of the foot on said body with respect to the connecting axis X₁ in order to increase the pedalling torque, and orient said pedal body in a defined plane during the rotation of the crank over a pedal cycle.

The invention also relates to city cycles and competition cycles that are equipped with this type of pedal.

Other advantages and characteristics of the present invention will emerge more clearly from a reading of the description given below by way of a non-limiting illustration of the invention, with reference to the accompanying drawings in which:

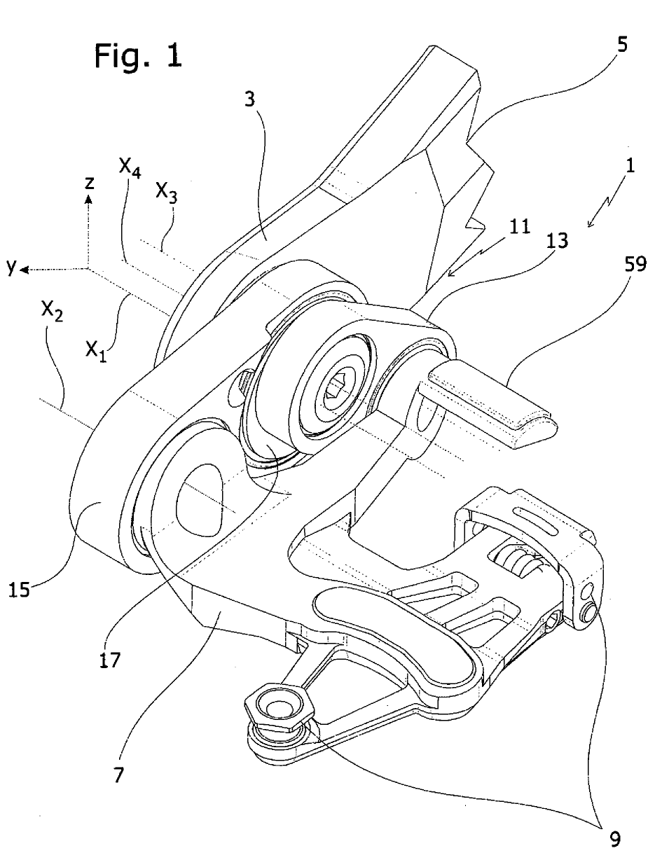

FIG. 1 depicts an overall view of a particular embodiment of the pedal according to the invention;

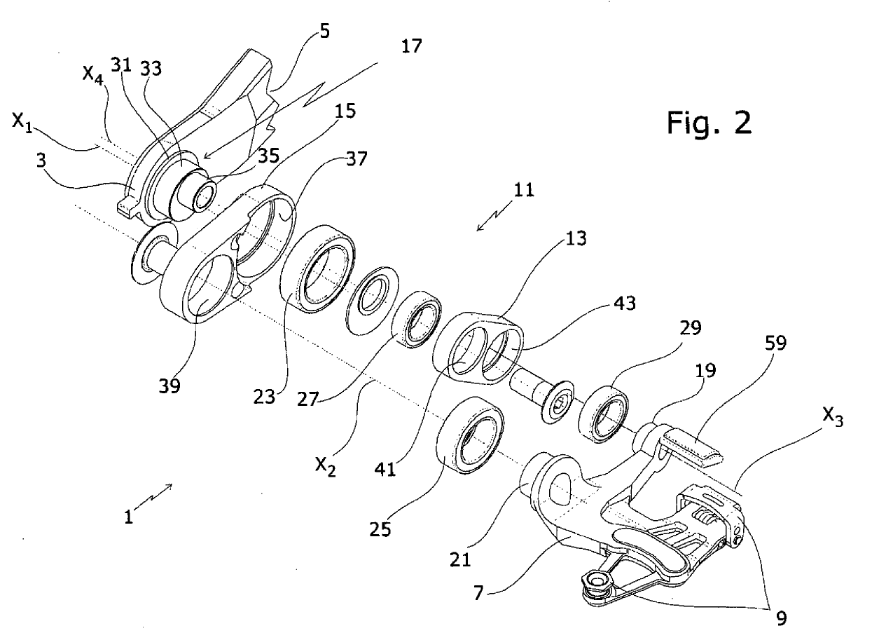

FIG. 2 depicts an exploded view of the pedal according to this particular embodiment;

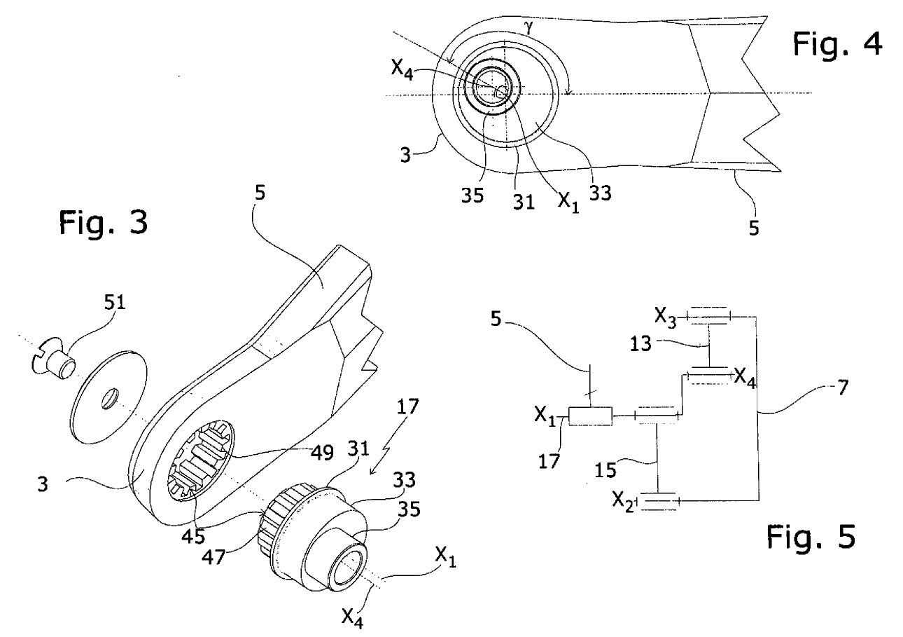

FIG. 3 depicts an exploded view of the assembly of a constituent component of the intermediate pantograph device, in accordance with FIGS. 1 and 2;

FIG. 4 depicts a plan view in accordance with FIG. 3 of the component assembled on the crank;

FIG. 5 depicts a kinematic diagram of the pantograph device implemented on the pedal shown in FIGS. 1 to 4;

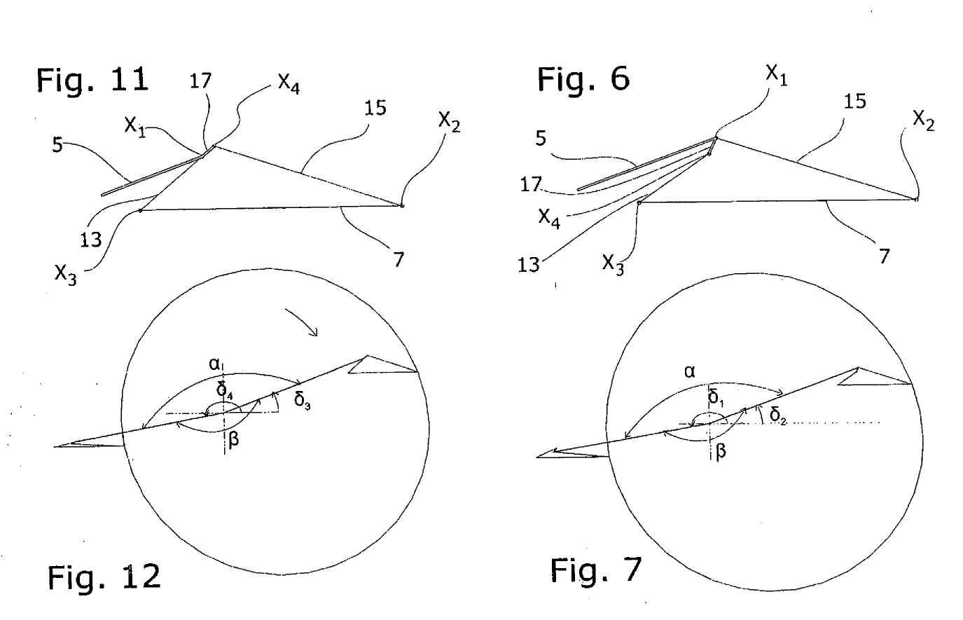

FIGS. 6 and 7 relate to a dynamic depiction of the pedal in accordance with FIGS. 1 to 5;

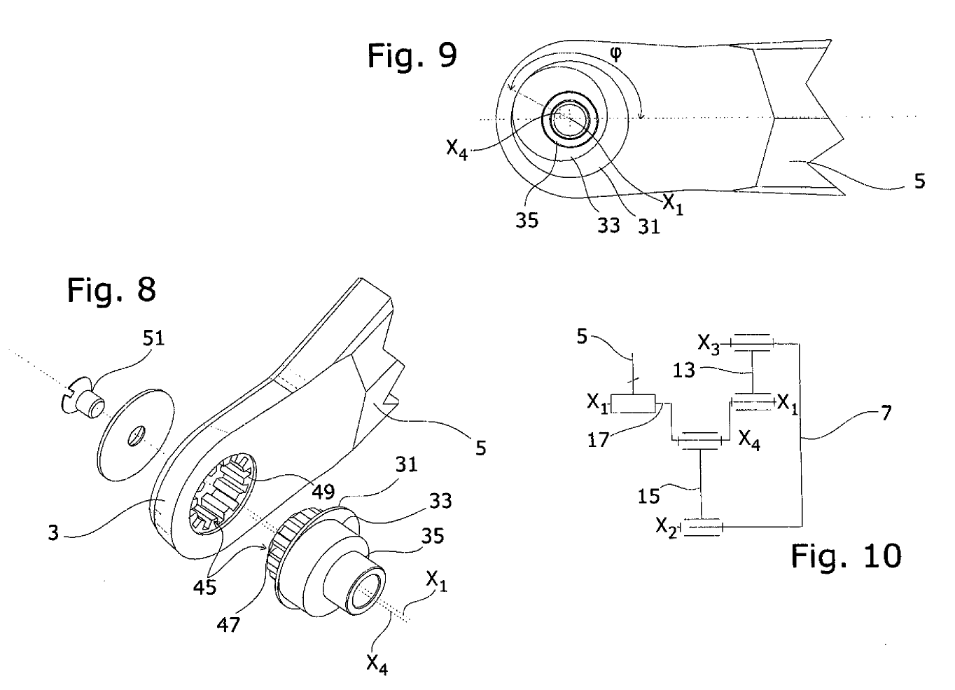

FIGS. 8 and 9 depict a design variant of a constituent component of the intermediate pantograph device;

FIG. 10 depicts a kinematic diagram of a pantograph device in accordance with the variant depicted in FIGS. 8 and 9;

FIGS. 11 and 12 relate to a dynamic depiction of the pedal in accordance with the variant depicted in FIGS. 8 to 10.

The cycle pedal 1 according to the invention is mounted at the end 3 of a crankset crank 5, said crankset (not depicted) preferably having technical characteristics similar to those described in the French patent applications registered under numbers FR 05 00505 and FR 05 11607.

The pedal 1 comprises a main body 7 on which there presses, during pedalling, either the left foot or the right foot of the cyclist, depending on whether it is a left pedal or a right pedal. The design of the body 7 is adapted according to the cycle type it is intended to equip; thus city cycles are preferably equipped with flat standard pedals, not depicted in the figures, possibly comprising serrations or notches making it possible to grip the soles of shoes of the cyclist, whilst competition cycles comprise pedals provided with means 9 of clamping the shoe, such as for example toe-clips or a latching device adapted to competition shoes.

The pedal 1 is assembled with the crank 5, at its end 3, according to a connecting axis X₁. The pedal 1 is remarkable in that it comprises a pantograph device 11 allowing the assembling of the body 7 of the pedal 1 with the crank 5. This pantograph device 11 has two functions: first of all that of creating a shift of the point of pressing of the foot on said body 7 with respect to the axis X₁ in two defined directions y and z in the same plane perpendicular to the connecting axis X₁, and that of orienting the body 7 in a defined plane during rotation of the crank over a pedalling cycle, making it possible for example to keep the body 7 in a substantially horizontal plane when the foot leaves the pedal 1. Shifting the point of pressing on the pedal 1 with respect to the connecting axis X₁ makes it possible to increase the pedalling torque, which makes it possible to reduce the pedalling force for a delivered power comparable to that of conventional pedals; the cyclist thus saves energy. Orientation of the body 7 of the pedal 1 according to a defined plane makes it possible to dispose the foot of the cyclist according to a certain inclination, in harmony with the position of the body and that of the legs of the cyclist, said inclination making it possible to best optimise the force exerted by the cyclist on the pedal 1 during pedalling. Maintaining the orientation of the body 7 of the pedal 1, for example in a substantially horizontal plane, makes it possible to facilitate the repositioning of the foot on said body 7 of the pedal 1.

The pantograph device 11 consists of a mechanism assembled with the crank 5 and the body 7 of the pedal 1. As shown in FIG. 1, the pantograph device 11 is assembled with the crank 5 according to a connection having axis X₁, and assembled with a double pivot connection with the pedal body 7 according to two axes X₂ and X₃. The mechanism of the device 11 comprises means arranged in order to impose the orientation of the body 7 of the pedal 1 according to a defined plane when the crank 5 is situated in an angular arc α, depicted in FIGS. 7 and 12, limits lying between 0° and 360°, and to leave the orientation of said body 7 free when the crank 5 is situated in an angular arc β, depicted in FIGS. 7 and 12, limits lying between 0° and 360°, said angular arc β being complementary to the first angular arc α. For this, and as depicted in FIGS. 1 and 2, the mechanism of the pantograph device 11 comprises a support linkage 13, a secondary linkage 15 and a cam 17, the secondary linkage 15 and support linkage 13 being respectively assembled with the body 7 according to the two axes X₂ and X₃. The cam 17 is assembled with the crank according to the axis X₁, with one of the linkages also according to the axis X₁ and with the other linkage according to an axis X₄ offset with respect to X₁.

According to an embodiment corresponding to FIGS. 1 and 2, and to the kinematic diagram of FIG. 5, the cam 17 is mounted on the crank 5 according to a connection having axis X₁; the support linkage 13 is mounted with a pivot connection having axis X₄ on the cam 17 and with a pivot connection having axis X₃ on the cylindrical part 19 situated at the rear of the body 7; the secondary linkage 15 is mounted with a pivot connection having axis X₁ on the cam 17 and with a pivot connection having axis X₂ on the cylindrical part 21 situated at the front of the body 7. As depicted in FIG. 2, the pivot connections are implemented preferably by means of ball bearings 23, 25, 27, 29, according to the axes X₁, X₂, X₃ and X₄, said axes being parallel to one another.

As depicted in FIGS. 1 to 4, the cam is made up of a shaft consisting of three cylindrical parts 31, 33, 35. The first part 31 is mounted at the end 3 of the crank 5 according to the axis X₁. The second part 33 having axis X₁ is mounted on the bearing 23 in a bore 37 provided at one of the ends of the secondary linkage 15, the other end of the secondary linkage 15 also comprising a bore 39 having axis X₂ which receives a bearing 25 mounted on the cylindrical part 21 provided at the front of the body 7 of the pedal 1. The third offset part 35 having axis X₄, shifted with respect to the axis X₁, is mounted on the bearing 27 in a bore 41 provided at one of the ends of the support linkage 13, the other end of the support linkage 13 also comprising a bore 43 having axis X₃ which receives a bearing 29 mounted on the cylindrical part 19 provided at the rear of the body 7. These two cylindrical parts 19, 21 are preferably directly moulded in the material of the body 7 of the pedal 1.

The connection between the first part 31 of the cam 17 and the end 3 of the crank 5 is, according to a preferential embodiment, of the flush-fitting type. As depicted in FIG. 3, the pantograph device 11 comprises means 45 for adjusting the angular position of the cam 17 flush-fitted on the crank. These adjustment means 45 advantageously make it possible to adjust the angular position of the cam over 360° with respect to a defined position of the crank. This is because this adjustment makes it possible to modify the position of the third part 35 of the cam defined according to the axis X₄, and therefore to transform the pantograph assembled on the crank. The path described by the pedal with respect to the axis of rotation of the crank during pedalling is thus modified. This adjustment has the advantage of best adapting the cycle equipped with the pedals according to the invention to the morphology of the cyclist.

The adjustment means 45 comprise a toothed pinion 47 implemented on the first part 31 of the cam 17 and a toothed hub 49 implemented on the crank 5. Engaging of the pinion 47 with the hub 49 makes it possible to rotationally immobilise, according to the axis X₁, the cam 17 with respect to the crank 5, translational immobilisation according to this axis X₁ being obtained by a translational securing screw 51, depicted in FIGS. 3 and 8. The flush-fitting connection having axis X₁ of the cam 17 on the crank 5 is thus constituted.

As depicted in FIG. 4, the pinion 47 engages on the hub 49 according to the axis X₁, the engagement position making it possible to define a setting angle γ of the cam on the crank, said setting angle γ being chosen according to a defined position of the crank, such as for example a horizontal position of the crank on the cycle crankset, as shown in FIG. 4. Modification of the setting angle γ therefore makes it possible to modify the position of the axis X₄ according to which the pivot connection between the third part 35 of the cam 17 and the support linkage 13 is implemented.

According to a variant embodiment shown schematically in FIG. 10, the cam 17 is mounted on the crank 5 according to the connection having axis X₁, the support linkage 13 is mounted with a pivot connection having axis X₁ on the cam 17 and with a pivot connection having axis X₃ on the cylindrical part 19 situated at the rear of the body 7, and the secondary linkage 15 is mounted with a pivot connection having axis X₄ on the cam 17 and with a pivot connection having axis X₂ on the cylindrical part 21 situated at the front of the body 7. In this case, the cam 17 is as shown in FIGS. 8 and 9 having a design close to that shown in FIGS. 1 and 2 corresponding to the first embodiment, except that the cam is implemented on the second cylindrical part 33 which then has axis X₄, whilst the third cylindrical part 35 is centred, having axis X₁ identical to that of the first cylindrical part 31 assembled on the end 3 of the crank 5.

According to this variant, and as depicted in FIGS. 8 and 9, the first part 31 and the third part 35 are defined according to the axis X₁, whilst the second part 33 is defined according to the axis X₄. As shown in FIG. 8, the pantograph device 11 comprises the means 45 for adjusting the angular position of the cam 17 with respect to the crank 5, as described previously, making it possible, according to this embodiment, to modify the position of the second part 33, defined according to the axis X₄, with respect to the crank 5. The position of engagement of the toothed pinion 47 of the cam 17 with the hub 49 of the crank 5 makes it possible to define a setting angle φ of the cam 17 on the crank 5, said setting angle φ being chosen for a defined position of the crank 5, such as for example a horizontal position of the crank on the cycle crankset, as shown in FIG. 9. Modification of the setting angle φ therefore makes it possible to modify the position of the axis X₄ according to which the pivot connection between the second part 33 of the cam 17 and the secondary linkage 15 is implemented.

An example implementation of the pantograph device 11 provided with a cam 17 in accordance with FIGS. 3 and 4, corresponding to the first embodiment, consists of adjusting the setting angle γ to a value of 315°, in the trigonometric direction. With reference to FIG. 6, a cam 17 having a distance between the axes X₁ and X₄ equal to 5 mm, a secondary linkage 15 having a distance between the axes X₁ and X₂ equal to 60 mm, a support linkage 13 having a distance between the axes X₄ and X₃ equal to 25 mm and a pedal body 7 having a distance between the axes X₂ and X₃ equal to 79.8 mm are used.

There is then obtained the dynamic diagram depicted in FIG. 7 for which the pedal body 7 is oriented in a horizontal plane, this horizontal position of the body 7 being imposed when the crank 5 is situated in the angular arc α, depicted in FIG. 7, whilst the pedal is left free as regards orientation, and can be positioned horizontally, when the crank 5 is situated in the angular arc β, depicted in FIG. 7, which is complementary to the angular arc α. For these values, the horizontal position of the pedal body 7 is imposed when the crank 5 is situated in the angular arc α lying between δ₁ and δ₂, defined in FIG. 7, where δ₁ is equal to 20° and δ₂ is equal to 190°.

A second example implementation of the pantograph device 11 provided with a cam 17 in accordance with FIGS. 8 and 9, corresponding to the variant embodiment, consists of adjusting the setting angle φ to a value of 135°, in the trigonometric direction. With reference to FIG. 11, a cam 17 having a distance between the axes X₁ and X₄ equal to 5 mm, a secondary linkage 15 having a distance between the axes X₄ and X₂ equal to 60 mm, a support linkage 13 having a distance between the axes X₁ and X₃ equal to 25 mm and a pedal body 7 having a distance between the axes X₂ and X₃ equal to 79.8 mm are used.

There is then obtained the dynamic diagram depicted in FIG. 12 for which the pedal body 7 is oriented in a horizontal plane, this horizontal position of the body 7 being imposed when the crank 5 is situated in the angular arc α, depicted in FIG. 12, whilst the pedal is left free as regards orientation, and can be positioned horizontally, when the crank 5 is situated in the angular arc β, depicted in FIG. 12, which is complementary to the angular arc α. For these values, the horizontal position of the pedal body 7 is imposed when the crank 5 is situated in the angular arc a lying between δ₃ and δ₄, depicted in FIG. 12, where δ₃ is equal to 20° and δ₄ is equal to 190°.

The present invention also relates to cycles equipped with pedals 1 as described previously. The cycle comprises a crankset, generally with several chainrings (not depicted), and is provided with two cranks, left and right, which each receive, at their end, a pedal 1, the object of the invention, respectively left and right. The cranks are preferably symmetrical with each other with respect to the sagittal plane of the cyclist when he is in a seated position on the saddle of said cycle. The left pedal has its pantograph device 11 positioned and adapted on the right lateral side of the body in order to couple onto the left crank, as shown in FIG. 1, whilst the right pedal has its pantograph device positioned and adapted on the left lateral side of the body in order to couple onto the right crank.

The pedal 1 according to the invention can equip both city cycles and competition cycles. In the case of city cycles, the body 7 of the pedal is, according to a preferential embodiment, not depicted, flat in shape and possibly provided with gripping means such as serrations or teeth.

When the pedal 1 according to the invention equips competition cycles, the body 7 then comprises means 9 of clamping a shoe of a cyclist. These clamping means 9 can be for example toe-clips or else a device for latching the shoe onto the pedal body.

According to a preferential embodiment, depicted in FIGS. 1 and 2, the pedal 1 comprises a positioning lever 59. This positioning lever 59 allows better manipulation of the body 7 for modifying its inclination and possibly turning the crank around the crankset in order that said crank can be positioned suitably according to the specific character of the cyclist, and thus facilitate the engaging of the shoe on the clamping means 9.

The positioning lever 59 is preferably directly moulded in a single piece and forms an integral part of the pedal body. A piece added onto the body for its implementation can however be envisaged.

According to a variant, a pivot type connection having axis X₁ between the pantograph device 11 and the crank can be designed, replacing the flush-fitting connection described previously. In this case, the part 49 in the middle on the crank 5 can, for example, be mounted with a pivot connection with said crank 5.

Other embodiments of the pedal can be envisaged within the scope of the present invention which more particularly finds its application in the cycling industry and trade.

1. Cycle pedal (1) mounted at the end (3) of a crankset crank (5), comprising a main body (7) on which a cyclist foot presses during pedalling, said pedal (1) being assembled, according to a connecting axis X₁, with the crank (5), characterised in that the pedal (1) comprises an intermediate pantograph device (11) making it possible to assemble the body (7) of the pedal (1) with the crank (5) while at the same time creating a variable shift of the point of pressing of the foot on said body (7) with respect to the connecting axis X₁ in order to increase the pedalling torque, and orient said body (7) in a defined plane during the rotation of the crank over a pedalling cycle.

2. Cycle pedal (1) according to claim 1, characterised in that the pantograph device (11) consists of a mechanism assembled with a connection with the crank (5) according to a connection having axis X₁, and assembled with a double pivot connection with the pedal body (7) according to two axes X₂ and X₃.

3. Cycle pedal (1) according to claim 2, characterised in that the mechanism of the device (11) comprises means arranged in order to impose the orientation of the body (7) of the pedal (1) according to a defined plane when the crank (5) is situated in an angular arc α, limits lying between 0° and 360°, and to leave the orientation of said body (7) free when the crank (5) is situated in an angular arc β lying between zero and three hundred and sixty degrees [0°; 360°], said angular arc β being complementary to the first angular arc α.

4. Cycle pedal (1) according to claim 3, characterised in that the mechanism of the pantograph device (11) comprises a support linkage (13), a secondary linkage (15) and a cam (17), the linkages (13, 15) being assembled with the body (7) according to the axes X₂ and X₃ and the cam (17) being assembled with the crank (5) according to the axis X₁, and in that one of the linkages (13, 15) is assembled with the cam (17) according to the axis X₁ and the other according to an axis X₄ offset with respect to the axis X₁.

5. Cycle pedal (1) according to claim 4, characterised in that the cam (17) is mounted with a connection having axis X₁ on the crank (5), the support linkage (13) is mounted with a pivot connection having axis X₄ on the cam (17) and with a pivot connection having axis X₃ on a cylindrical part (19) at the rear of the body (7), and the secondary linkage (15) is mounted with a pivot connection having axis X₁ on the cam (17) and with a pivot connection having axis X₂ on a cylindrical part (21) at the front of the body (7).

6. Cycle pedal (1) according to claim 4, characterised in that the cam (17) is mounted on the crank (5) according to a connection having axis X₁, the support linkage (13) is mounted with a pivot connection having axis X₁ on the cam (17) and with a pivot connection having axis X₃ on a cylindrical part (19) at the rear of the body (7), and the secondary linkage (15) is mounted with a pivot connection having axis X₄ on the cam (17) and with a pivot connection having axis X₂ on a cylindrical part (21) at the front of the body (7).

7. Cycle pedal (1) according to claim 4, characterised in that the pantograph device (11) comprises means (45) for adjusting the angular position of the cam (17) on the crank (5) making it possible to modify the position of the pantograph with respect to the crank and thus modify the path of the pedal with respect to the axis of rotation of the crank during a pedalling cycle.

8. Cycle pedal (1) according to claim 7, characterised in that the adjustment means (45) comprise a toothed pinion (47) on the cam (17) which engages in a toothed hub (49) on the crank (5), the engagement between the cam (17) and the crank (5) being defined according to the axis X₁ and making it possible to modify the setting of the cam (17) on the crank (5).

9. Cycle pedal (1) according to claim 1, characterised in that the pedal body (7) comprises means (9) for clamping a shoe of a cyclist.

10. Cycle pedal (1) according to claim 1, characterised in that the pedal (1) comprises a positioning lever (59) for the body (7) in order to facilitate the clamping of the shoe on said body (7).

11. Cycle comprising a crankset provided with two cranks, left and right, characterised in that it is equipped with pedals according to claim 1, the left crank receiving a left pedal and the right crank receiving a right pedal.

12. Cycle pedal (1) according to claim 5, characterised in that the adjustment means (45) comprise a toothed pinion (47) on the cam (17) which engages in a toothed hub (49) on the crank (5), the engagement between the cam (17) and the crank (5) being defined according to the axis X₁ and making it possible to modify the setting of the cam (17) on the crank (5).

13. Cycle pedal (1) according to claim 6, characterised in that the adjustment means (45) comprise a toothed pinion (47) on the cam (17) which engages in a toothed hub (49) on the crank (5), the engagement between the cam (17) and the crank (5) being defined according to the axis X₁ and making it possible to modify the setting of the cam (17) on the crank (5).
